(19) United States
(12) Patent Application Publication
(10) Pub. No.: US 2006/0000251 A1
(43) Pub. Date: Jan. 5, 2006

(54) Rotor and keys for a locking device, the locking device equipped with such a rotor and keys, and the use thereof

(75) Inventors: Daniel Ceron, Transinne (BE); Pascal Balon, Etalle (BE); Christophe Grandjean, Arlon (BE)

Correspondence Address: OSTROLENK FABER GERB & SOFFEN, 1180 AVENUE OF THE AMERICAS, NEW YORK, NY, 100368403, US

(73) Assignee: Euro-Locks S.A.

(21) Appl. No.: 10/972,741

(22) Filed: Oct. 25, 2004

(30) Foreign Application Priority Data
Jun. 30, 2004 (BE) BE 2004/0325

(51) Int. Cl. E05B 29/04

(52) U.S. Cl. 70/492

(57) ABSTRACT

Rotor for a rotor-type locking device operated by a key, said rotor presenting: a central chamber; a series of slots; locking tumblers with nib, in which at least one tumbler is brought into the unlocked position by a displacement in a direction different from the unlocking direction of at least two other tumblers, the nibs of said tumblers extending along a same face of the chamber.

### FIELD OF THE INVENTION

The present invention concerns a rotor for a locking device that is at least opened or unlocked by the operation of a key.

### THE PRIOR ART

Many locking devices are known on which the rotor is key-operated.

According to one conventional form of embodiment, a key having teeth on its edges acts on spigots or projections on locking tumblers so as to lower or raise them. It has been observed that rotor-type locking devices operated with such a key have often been targeted by picklocks. It is relatively easy for unauthorised persons to pick these types of lock using fine metal blades and hooked tools.

In order to make locks more difficult to pick, the use of fluted keys has been proposed. These fluted keys feature a control flute on both their plane faces, the flute situated on the left being designed to operate the tumblers whose nibs are on the left, whereas the flute situated on the right is designed to operate the tumblers whose nibs are on the right. Despite the fact that these locking devices offer greater security, it has been observed that fraudsters still succeed in picking them.

The object of the present invention is a locking device that is even more difficult to pick.

### DESCRIPTION OF THE INVENTION

One important element of the invention is the rotor of the locking device, said rotor being operated by a key. The object of the invention is therefore a rotor featuring:
a central chamber with at least one aperture adapted for the introduction of at least part of the key into the chamber;
a series of slots which communicate with the central chamber;
locking tumblers which respectively slide in a slot under the action of a return spring, with each tumbler featuring a control nib designed to cooperate with the key introduced into the chamber, so as to move each tumbler into the unlocking position against the action of a means of return, more particularly a return spring.

In the rotor according to the invention, at least one tumbler is brought into the unlocked position by a displacement in a different direction, advantageously at least partially opposed (and preferably substantially opposed) to the direction of displacement of not less than two tumblers, so as to bring them into the unlocked position, the nibs of said minimum of three tumblers extending at least partly into the chamber, along the same internal face thereof. This accordingly makes the lock difficult to pick, since it is necessary to displace one nib in one direction (for example downwards), while it is necessary to displace two other nibs, advantageously adjacent to the first, in an opposite direction (for example upwards).

From the outside, the fraudster will be unable to tell whether one or more nibs need to be displaced downwards while others need to be displaced upwards in order to permit the device to be unlocked. This therefore makes it possible to substantially complicate the picking of a lock by a fraudster.

Advantageously, the rotor will have at least four locking tumblers, at least two tumblers being brought into the unlocked position by a displacement in a different direction, advantageously at least partly opposed (and preferably substantially opposed) to the direction of displacement of at least two other tumblers, so as to bring them into the unlocked position.

The rotor preferably has at least five, more particularly at least seven locking tumblers. The rotor may for example comprise 8, 9, 10, 11 or even more tumblers. As a general rule, from 7 to 9 tumblers permit an adequate level of security to be provided.

It should be noted that the more tumblers are provided, the greater will be the number of combinations and the level of security.

Under one specific form of embodiment, the chamber features a first and second internal faces arranged opposite one another, with at least one nib controlling three tumblers being turned towards the first internal face, whereas at least one nib controlling another tumbler is turned towards the second internal face. This allows the possible combinations to be still further increased, particularly if the key is a single-entry key.

Under one preferred embodiment, at least one tumbler features a control nib and a spigot or projection which are adapted to permit the tumblers to be brought into the unlocking position by means of a master key. This master key will for example feature a channel or flute capable of unlocking one or more tumblers and teeth or projections along at least one of its edges capable of unlocking one or more other tumblers by operating on the spigots or projections thereof.

As a result, a rotor thus equipped can then be actuated by a servant key (i.e. the usual key for the rotor) of which the channel on one face operates the nibs of all the tumblers, as well as by the master key which operates certain tumblers by the channel on the nibs and other tumblers by the action of the teeth on the spigots of these other tumblers.

According to a detail of one embodiment, the rotor features a chamber with a longitudinal axis corresponding to the key insertion axis and a substantially rectangular cross-section. The nibs of the tumblers are adapted to cooperate with a key featuring on at least one of its faces a defined channel between a first longitudinal edge and a second longitudinal edge, the first edge being adapted to displace one or more nibs of one tumbler or first group of tumblers in a first direction, while the second edge is adapted to displace one or more nibs of a second tumbler or second group of tumblers in an opposite direction from the first direction.

According to one embodiment, the control nibs of the tumblers are situated only along one face of the central chamber, with the result that it is adapted to cooperate with a key featuring on only one face a channel for operating tumbler nibs and, if appropriate, one or more teeth on the bitting or bittings, with said tooth or teeth being adapted to act on one or more of the tumbler spigots.

Specifically, the chamber features a central chamber defined between at least a first face and a second face situated opposite one another, whereas the nibs that control the tumblers are situated solely along the first face or second face of the central chamber, with the result that it is adapted to cooperate with a key featuring a tumbler nib control channel on only a first face or on the opposing face thereof, the key possibly furthermore featuring one or more teeth on the bitting or bittings, and said tooth or teeth being adapted to act upon one or more tumbler spigots.

It is preferred if the control nibs of the tumblers are of substantially the same width, the longitudinal edges of the groove being spaced apart from one another by a minimum distance corresponding at least to the maximum width of the tumbler control nib. If appropriate, the nibs will be of variable width, for example the nibs will be narrower in respect of one or more tumblers adjacent to the aperture for introducing the key into the chamber. In this case the channel will be sufficiently wide to allow the passage and sliding of the nibs of the various tumblers in the channel.

Advantageously, certain tumblers, as well as their nibs, are adapted to cooperate with a key having a channel of substantially variable width, said variable width being not less than the width of the biggest of the nibs. The key for example features a control channel on only one of its lateral faces, the key then being a single-entry key. The other face of the key may then have a profile adapted to allow guidance and/or to only allow the key to be introduced into a special rotor with a suitable profile. The key may also have symmetrical control channels on both of its opposing lateral faces, so that in this instance the key is a double-entry key.

According to a special feature of one embodiment, the tumblers are accommodated in slots equidistant or different distances apart from one another, or else in slots forming at least two distinct groups of slots, said groups being equidistant from one another or different distances apart.

According to yet another detail, some tumblers, along with their nibs, are adapted to cooperate with a key channel of variable width, said channel extending in a defined zone between two longitudinal lines spaced apart by a distance corresponding at least to the width of the nibs. Advantageously, the maximum width separating the two longitudinal lines will be a function of the distance between the extreme positions of the nibs in the various tumblers.

According to one detail, the tumblers are selected from at least one group of at least three tumblers featuring a nib one edge of which, cooperating with an edge of the key channel, extends between two extreme positions.

The nib of the tumblers may be of variable or constant width and/or variable or identical shape.

According to a special feature of one embodiment, the nib of at least one tumbler presents a face that slopes with respect to the plane perpendicular to the tumbler's direction of movement and/or is rounded (i.e. curved), said nib being adapted to cooperate with a sloping and/or rounded edge of a channel incorporated on a key.

Another special feature may be a tumbler nib with a substantially triangular or trapezoidal or rounded shape. The channel in the key and the chamber of the rotor are then configured accordingly.

According to a special feature of one practical embodiment, the spring or springs acting on one or more tumblers against a movement in a first direction are all situated on a first side of the rotor, while the springs acting on one of the other tumblers against a movement in an opposite direction from said first direction are situated on a second side opposite the first side. In order to increase the number of combinations, each slot of the rotor may be operatively associated with a tumbler with motion in one direction or with a tumbler with motion in an opposite direction.

Advantageously, the springs operating on the tumblers are alternately spaced individually or unitarily or groupwise, notably in twos or threes, per tumbler or per group of tumblers.

Specifically, the springs of the tumblers or groups of tumblers are positioned in separate or diametrically opposed seats or so as to mirror one another.

According to a detail of one possible embodiment, one or more slots, or even each slot, receive one or more tumblers (notably two or three) sliding in the same direction as, or opposite direction from, one another, against the action of one or more springs.

According to one preferred embodiment, the rotor features at least one means for holding the rotor in a housing of a locking device or handle. Such a means is advantageously an open or closed retainer or staple, said retainer or staple advantageously being mounted so as to slide in a slot on the rotor, with the sliding action preferably being performed against the action of at least one spring. For example, the means for holding the rotor in the housing is a nib carried on the rotor, said nib being designed to slide or otherwise and/or being deformable or otherwise.

According to a detail of another preferred embodiment, the rotor has at least one means designed to cooperate with at least one tool or instrument, notably at least one removal key, in order to remove the rotor from its housing without damaging the rotor and its housing or without needing to dismantle the locking device or part thereof. The rotor can thus be removed in a straightforward manner using a suitable tool or key, thereby allowing one rotor to readily be replaced with another, as for example in the case of loss or theft of a servant key.

For example, the means designed to cooperate with at least one tool, notably at least one removal key, is at least one nib or one spigot, notably a nib or spigot mounted in advantageous manner on one or more legs of an open retainer, and a nib or spigot mounted on a closed retainer.

The retainer (30) is for example of the closed type (FIGS. 8, 8A, 8B) with two ends spaced apart from one another by a distance greater than the diameter of the portion of the rotor that is adjacent to the retainer. One of said ends extends in an annular groove on the housing in order to see to it that the rotor is retained in the housing.

According to one feature, the rotor is adapted to cooperate with a housing presenting an annular groove designed to receive at least part of the retainer for retaining the rotor in the housing, and at least one groove, more particularly two grooves, advantageously longitudinal and/or axial, with at least one groove opening partially or fully onto the annular groove.

The retainer preferably presents a first end that is broader than the longitudinal groove or grooves, and a second end that is narrower than the longitudinal groove that opens at least partially onto the annular groove.

According to another feature of one embodiment, the rotor is adapted to cooperate with a removal key, more particularly a straightforward elongate key, said key presenting either a channel designed to move, notably to lower or raise, a nib on the retainer and hence the retainer itself, or else an edge with a tooth which presses on a spigot on the retainer in order to move the latter, the movement of the retainer being sufficient to displace its broad end from the annular groove of the housing and only allow the rotor to be removed once the latter has been brought into an unlocked position. For example, the rotor is adapted to cooperate with a removal key that corresponds to a master key having a portion designed to control the removal of the rotor, said master key making it possible to release the rotor so as to arrive, notably following rotation thereof, at a rotor removal position or a position enabling the rotor to be removed by longitudinal displacement.

According to yet another embodiment, the retainer is of the double-ended closed type (FIG. 9) and has a transverse shape defined within a circle with a diameter essentially equal to or smaller than the diameter of the rotor portion accommodating the retainer.

It is practical for the rotor to have a nib, advantageously located in the plane of the slot in which the retainer slides.

Specifically, the retainer presents one broad end, characterised in that the nib of the rotor is positioned in an area not adjacent to the broad end of the retainer, the opposite side from the broad end of the retainer.

Advantageously, the rotor is adapted to cooperate with a housing presenting an annular groove designed to receive part of the retainer, a longitudinal slot allowing passage of the nib of the rotor, and at least two longitudinal grooves for tumblers, said two grooves opening or not onto the annular groove, or otherwise.

According to a further embodiment, the retainer having a control nib along one of its legs has its small end open.

According to yet another embodiment, the rotor is characterised by a closed retainer with two ends which are both essentially of the same width, advantageously smaller than the longitudinal grooves for tumblers, and by the fact that the rotor is adapted to cooperate with a housing presenting at least two longitudinal grooves for tumblers, one of which opens onto the annular groove.

It is clear that instead of using a rotor means or retainer that opens out into a groove, more particularly an annular groove, in the housing, it is possible to reverse the mechanism, i.e. to use a housing means or retainer that is movably mounted, said means or retainer opening out at least partially into a channel or groove, notably an annular groove on the rotor.

According to one practical detail, the rotor is characterised by the use of tumblers with control nibs situated along the two internal faces of the chamber (10) of the rotor, more particularly with the control nibs situated along the two faces being movable in both directions so as to further increase the number of possible combinations.

According to one specific embodiment, the rotor is adapted to operate with a single-entry key, notably a key incorporating a channel on each face, said two channels being asymmetrical; with or without teeth on the edges of the key.

A further object of the invention is a locking device or handle having at least one housing that cooperates with at least one rotor according to the invention, more particularly adapted to cooperate with a key or master key as defined above.

According to one locking device embodiment, in which the retainer presents a broad end and an element designed to engage in an annular groove on the housing, the housing presents a slope with a width essentially identical to or greater than the broad end of the retainer and advantageously situated at the start of a longitudinal groove for tumblers which does not open into the annular groove of the housing, said slope facing the broad end of the retainer in the correct position for inserting the rotor into the housing with or without the key introduced into the rotor, and advantageously without having to resort to a removal key.

According to one detail, the locking device is characterised by a closed retainer with two ends, both of which are of essentially the same width, advantageously smaller than the longitudinal grooves for tumblers, the housing furthermore presenting at least two longitudinal grooves for tumblers, one of which opens onto the annular groove.

The housing preferably presents a slope, said slope advantageously being situated at the end of at least one of the longitudinal grooves which do not open onto the annular groove.

A further object of the invention is a master key for a rotor in accordance with the invention. Specifically, this key presents at least one face incorporating a channel designed to act on nibs of tumblers and at least one edge incorporating teeth designed to act on spigots of tumblers.

Yet another object of the invention is the use of locking devices and handles according to the invention for protecting a series of cabinets or lockers.

By using such locking devices it is possible to greatly increase the ability of one or more cabinets or of one or more lockers to withstand being opened fraudulently.

Moreover, the rotor according to the invention may be used in existing housings that have a chamber suitable for receiving the rotor. This therefore advantageously makes it possible to readily replace rotors of existing locking devices with rotors according to the invention.

There are in existence many types of rotor assembly in housings of locking devices and handles, and this is well known in the world of locking device and handle manufacturers. The particular attraction of this invention is that it proposes a new design of rotor that can advantageously be inserted into an existing housing in place of an old rotor.

This makes it possible to greatly limit the cost of manufacturing locking devices and handles according to this new, invention because it allows existing housings to be used.

With security in mind, the use of the split key is envisaged for locking devices on, for example, office furniture, and the use of such keys with a rotor according to this new invention forms part of the claims (FIG. 15). Locking devices for motor vehicles currently use keys that fold away into a case in order to prevent any damage and risk of injury; and the use of such a system with a rotor and keys according to this invention forms part of the claims (FIG. 14).

Special features and details of preferred embodiments will become apparent from the detailed description that follows, referring to the accompanying drawings, wherein:

### BRIEF DESCRIPTION OF THE DRAWINGS

FIG. 1 is a perspective exploded view showing a rotor according to the invention and its operating key.

FIG. 2 is a similar view to FIG. 1, but showing a master key.

FIG. 3 is a scaled-up view of a tumbler featuring an upward unlocking movement.

FIG. 4 is a scaled-up view of a tumbler featuring a downward unlocking movement.

FIG. 5 is a scaled-up view of a key.

FIG. 6 is a scaled-up view of a master key.

FIG. 7A is a sectional view in the median plane of a rotor similar to that of FIG. 1, but featuring seven tumbler reception slots.

FIG. 7B is a sectional view of a rotor similar to that of FIG. 7A, but featuring seven tumbler reception slots and an additional slot for receiving a retainer.

FIG. 7C are an upper view, a back view and a sectional view of a rotor similar to that of FIG. 1, but featuring seven tumbler reception slots and an additional slot for receiving a retainer as seen in FIG. 9, operatively associated with a nib 40 on the rotor.

FIG. 8 is a view of a closed retainer incorporating two ends whose diameter is greater than or equal to the diameter of the rotor.

FIG. 8A is a variation on FIG. 8, showing a closed retainer with two ends where the width of the narrow end 31 is reduced in relation to the width of the body of the retainer.

FIG. 8B is a variation on FIG. 8, showing a closed retainer with two ends where the narrow end 31 is positioned above the broad end.

FIG. 8C shows an open retainer allowing insertion of the rotor but not the removal of the rotor.

FIG. 9 is a view of another closed retainer with two ends whose diameter is equal to or smaller than the diameter of the rotor and which is operatively associated with a nib 40 on the rotor body.

FIG. 10A shows a housing for inserting a rotor equipped with an open, and hence non-removable retainer (FIG. 8C), showing its slope, its annular groove 32 and its longitudinal grooves (42, 43).

FIG. 10B shows a housing for inserting a rotor equipped with a closed retainer as in FIG. 8, and hence removable from the housing. The housing has a slope, an annular groove 32, two longitudinal grooves (42, 43) only one of which (43) opens onto the annular groove 32.

FIG. 10C is a variation of FIG. 10B in which the rotor is equipped with a retainer as shown in FIG. 8A and the aperture between the annular groove 32 and the longitudinal groove 43 is reduced in order to adapt it to the retainer seen in FIG. 8A.

FIG. 10D shows a housing designed to receive a rotor equipped with a retainer as illustrated in FIG. 8B, with the narrow end accommodated above the broad end. Such a housing has its slope, its annular groove 32 and its longitudinal grooves (42, 43), but in this case it is groove 42 that opens onto the annular groove.

FIG. 10E shows a housing designed for the insertion of a rotor with the nib 40 and closed retainer illustrated in FIG. 9. The housing has a slope, an annular groove 32, two longitudinal grooves (42, 43) and a longitudinal groove 34 in which the rotor nib 40 slides.

FIGS. 11, 12 and 13 show scaled-up views of further embodiments of tumblers.

FIG. 14 shows a key for the rotor of the present invention, on which the working portion of the key can be folded away and inserted into a case.

FIG. 15 shows a split key.

FIG. 16 is a perspective view showing a single-entry key.

In the Figures the same reference numbers have been used to identify similar or identical parts.

### DESCRIPTION OF PREFERRED EMBODIMENTS

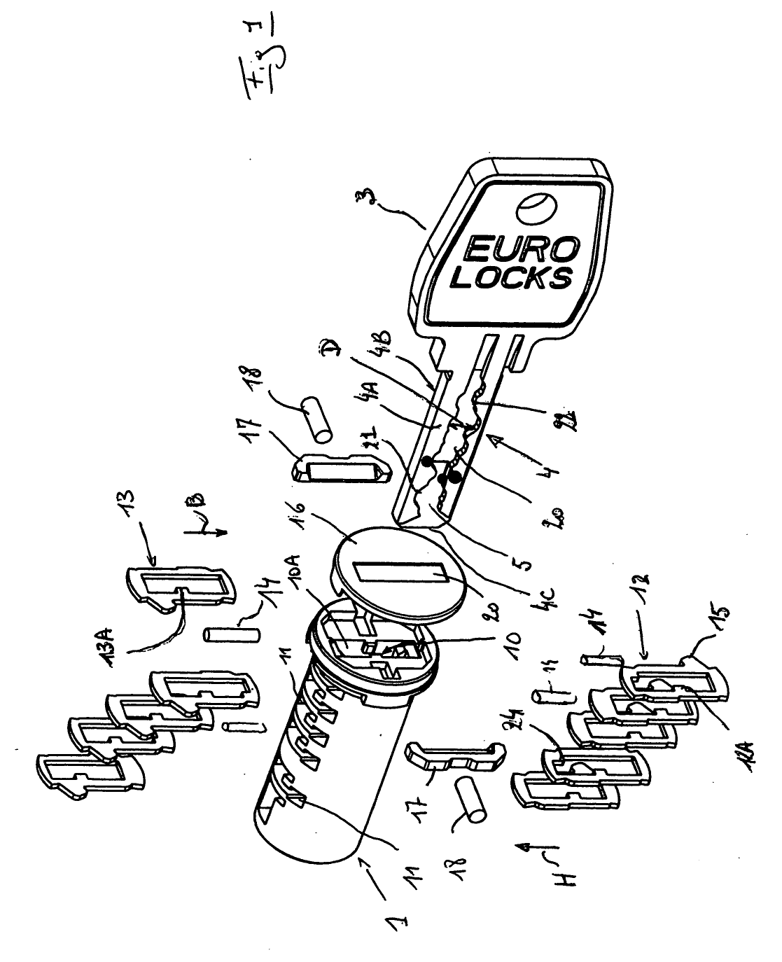

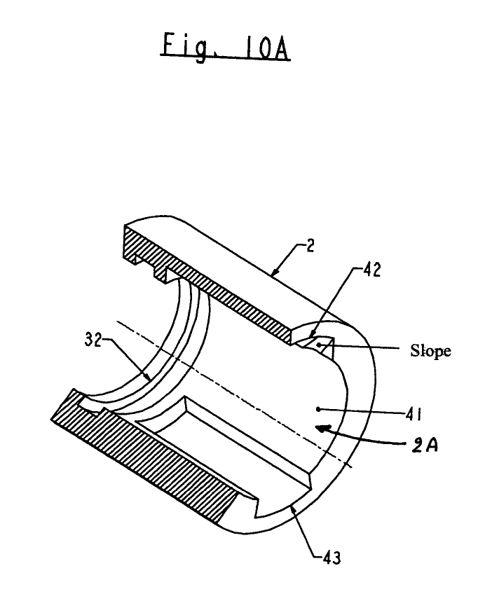

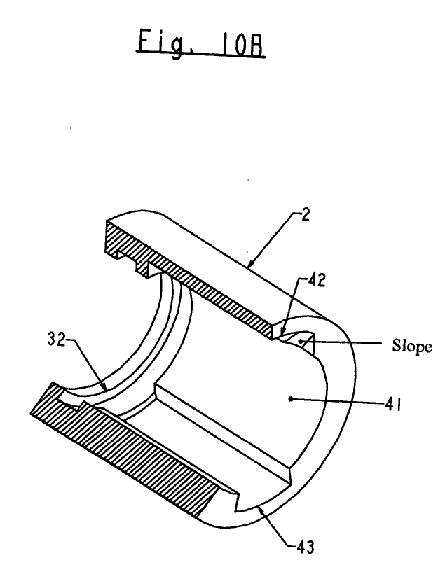

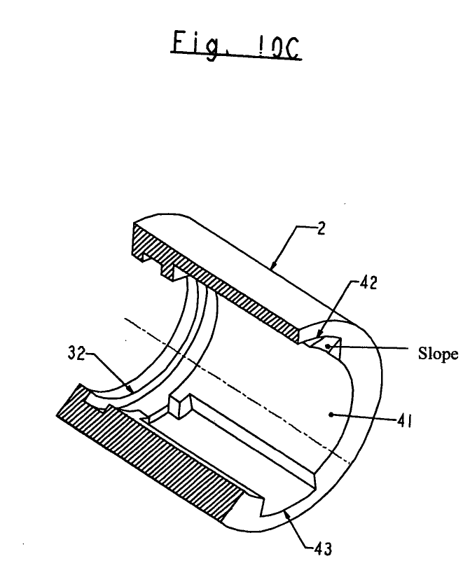

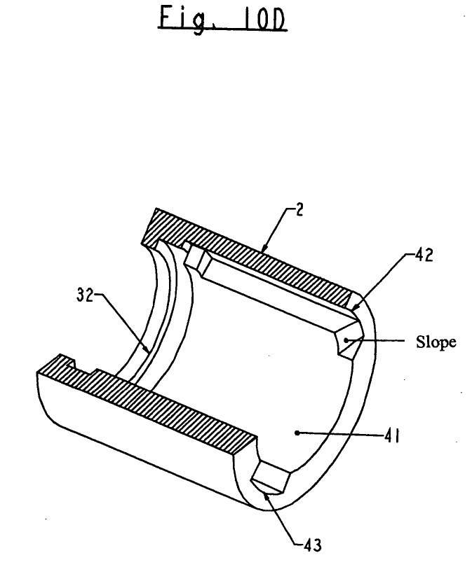

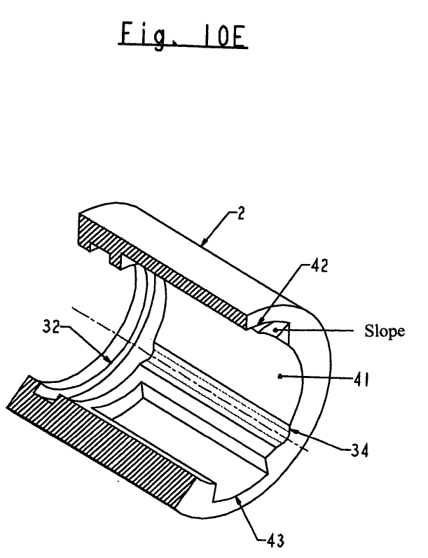

FIG. 1 shows a rotor 1 for a rotor-type locking device, said locking device comprising a housing 2 illustrated in FIG. 10A. The housing 2 (see FIGS. 10A,B and C) features a receptacle 2A designed to receive the rotor and adapted to allow the rotor to rotate between at least one locked position and one unlocked position. The unlocking of the rotor 1, and advantageously the locking of the rotor, are controlled by a key 3 presenting a flat side 4 whose opposing lateral faces 4A, 4B incorporate a channel 5. The rotor 1 presents:
a central chamber 10 with at least one aperture 10A adapted for the introduction of at least the flat side 4 of the key 3 into the chamber 10;
a series of slots 11 communicating with the central chamber 10;
locking tumblers 12, 13 respectively sliding in a slot 11 under the action of a return spring 14, each tumbler 12, 13 having a control nib 12A, 13A designed to cooperate with a channel incorporated in the flat side 4 of the key 3 introduced into the chamber 10 in order to bring each tumbler 12, 13 into the unlocked position against the action of a return spring 14, the return springs respectively extending between a finger 15 of a tumbler 12, 13 and a wall of a slot 11;
for outdoor applications or applications involving a dusty environment, it will be advantageous to protect the inside of the rotor, and to this end an escutcheon plate 16 and guards 17 designed to cover the front face of the rotor 1. On the face nearest the rotor 1, the escutcheon plate 16 has two guards 17 designed to move apart from one another against the action of the springs 18. In moving away from one another the guards 17 expose the aperture 20 of the escutcheon plate 16 and thereby allow the key 3 to be introduced. The movement of the guards away from one another is the result of the thrust of the end 4C of the flat side 4 of the key 3. To facilitate their movement apart, the guards 17 have a sloping portion 17A which is acted upon by the end 4C of the flat side 4 of the key.

In the embodiment illustrated, the rotor presents ten slots 11 for receiving tumblers 12, 13, for example five tumblers 12 and five tumblers 13. Tumblers 12 are brought into the unlocking position by an upward movement (H) against the action of their respective spring 14, whereas tumblers 13 are brought into the unlocking position by a downward movement (B) against the action of their respective spring 14.

The nibs 12A, 13A of the tumblers 12, 13 all extend over the same internal face of the chamber 10 of substantially rectangular cross-section. This means that the unlocking action necessitates an upward movement by some nibs and a downward movement by certain other nibs, which accordingly makes unauthorised unlocking a complex matter. The fraudster cannot tell whether and which tumblers need to be displaced downwards or upwards.

The tumblers 12, 13 present a substantially rectangular central passage whose width substantially corresponds to the maximum thickness of the flat side 4 of the key 3, whereas the height is greater than the maximum width of the flat side 4 in order to allow relative movement of the tumblers with respect to the flat side 4 of the key.

In the locked position, part of the tumblers extends into the cavities on the rotor, thereby preventing any rotation of the rotor 1 whenever the key 3 or master key 25 is not engaged in the chamber 10.

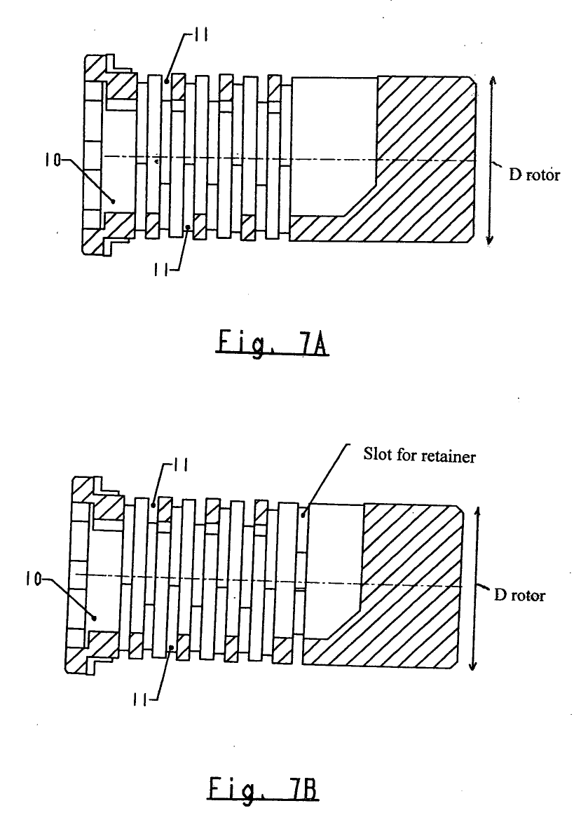

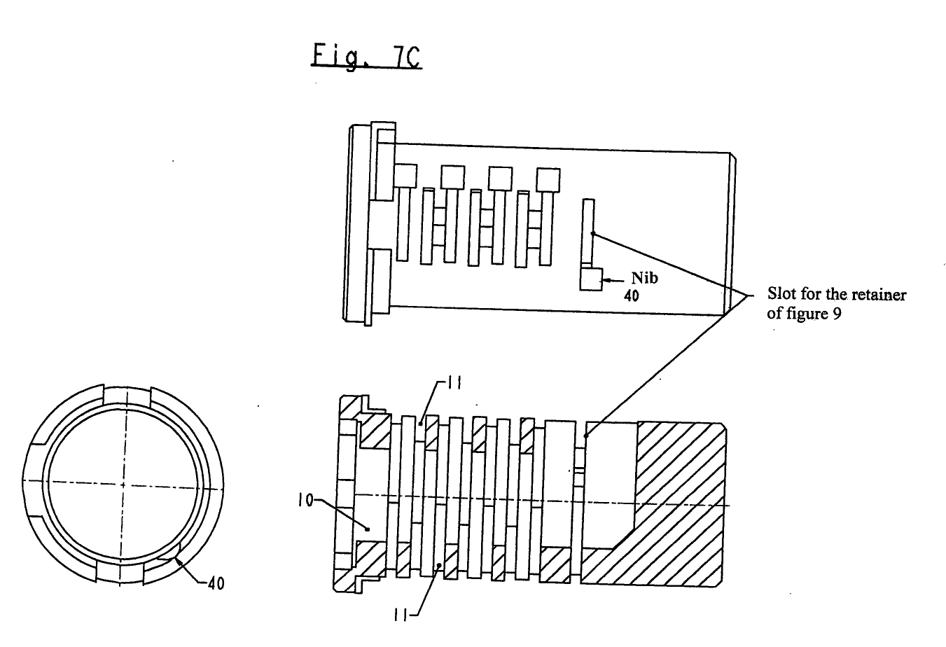

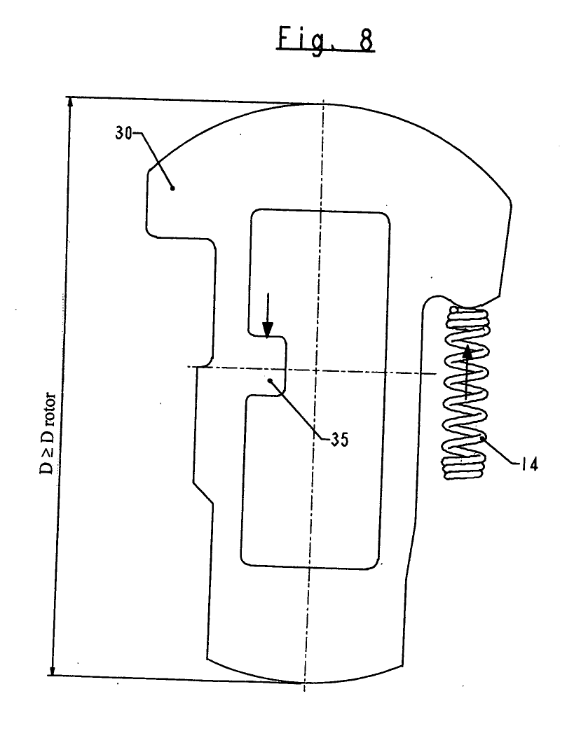

If in the embodiment shown in FIG. 1 the rotor 1 presents ten slots 11 designed to receive tumblers 12 or 13, it will be evident that in other embodiments the rotor may have a different number of slots 11 for tumblers 12 or 13, for instance seven slots 11 (see FIG. 7), five slots, nine slots, eleven slots, etc.

For example, the rotor 1 will have at least four locking tumblers, at least two tumblers 13 being brought into the unlocked position by displacement in an opposite direction (B) to the direction (H) of displacement of at least two tumblers 12 in order to bring them into the unlocked position.

It is likewise possible to use tumblers featuring a nib adjacent to the face lying opposite to the face along which the nibs of tumblers 12, 13 extend. This then enables the possible combinations to be further increased.

On each of its faces 4A, 4B the key 3 presents a channel 20 which extends between an upper edge 21 and a lower edge 22, the upper edge 21 being designed to push down the nibs of tumblers 13, while the lower edge 22 is designed to push up the nibs of tumblers 12. The lower and upper edges are spaced apart from one another by a distance DX, which varies but is at least equal to the width L of the nibs. The positioning of the nibs 12A, 13A on the tumblers may vary from one tumbler to another, which explains the curved, variable profile of the edges 21, 22.

To provide for the rotor to be unlocked by an authorised person who does not possess the key, it is advantageous to provide on one or more tumblers one or more spigots 24 designed to cooperate with a master key 25.

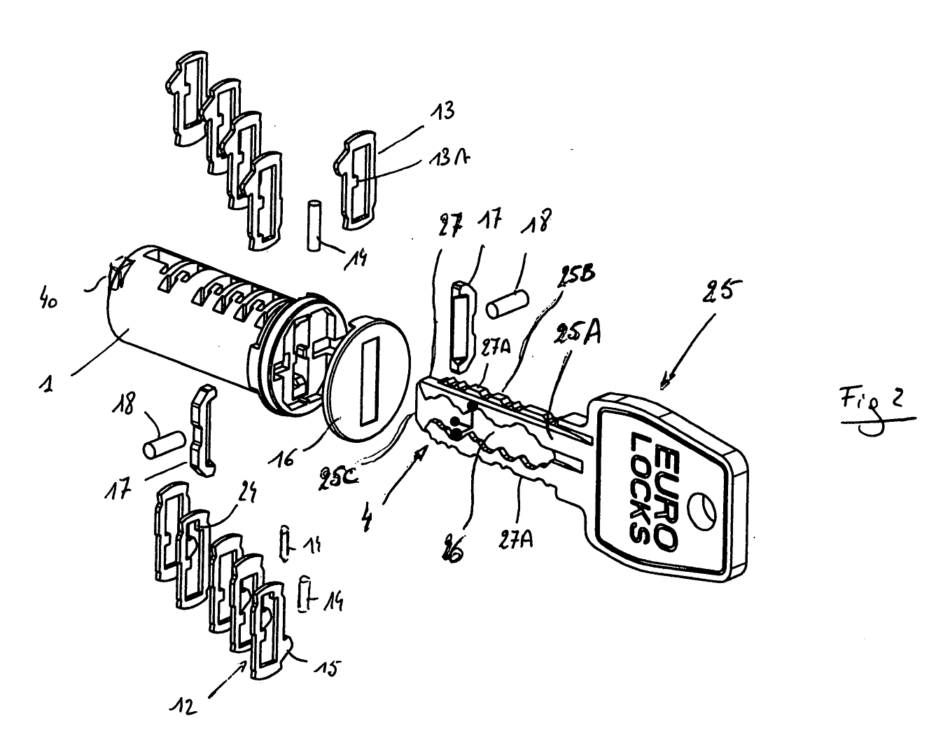

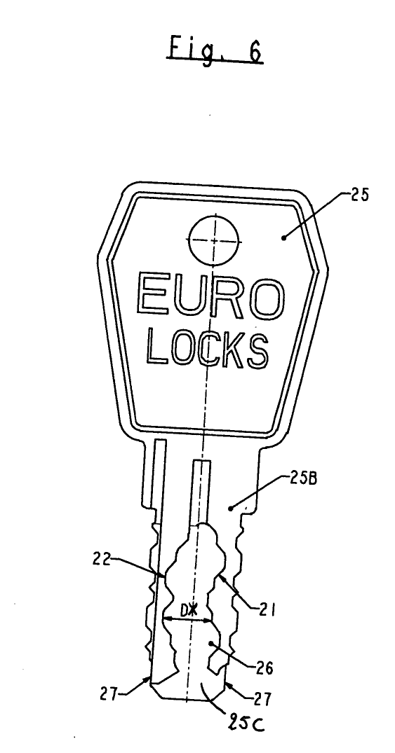

On its opposing faces 25A, 25B, this key 25 presents a channel 26 which is adapted to cooperate with one or more nibs of one or more tumblers from the two groups of tumblers, and on one or two edges 27 of the flat side 4, it presents one or more teeth 27A adapted to cooperate with one or more spigots or projections 24 on one or other tumbler(s) from the two groups of tumblers (see FIGS. 2 and 6).

This allows a high level of security to be provided in respect of a large number of keys, while having a single master key to unlock them in case of need or of loss of the key specific to a locking device (or the servant key).

By creating different shapes of channel 26 and/or of the teeth on the edge or edges 27, and by inserting specially adapted tumblers, the result is thus a different master key and a different series of combinations fitted by this or these other master key(s).

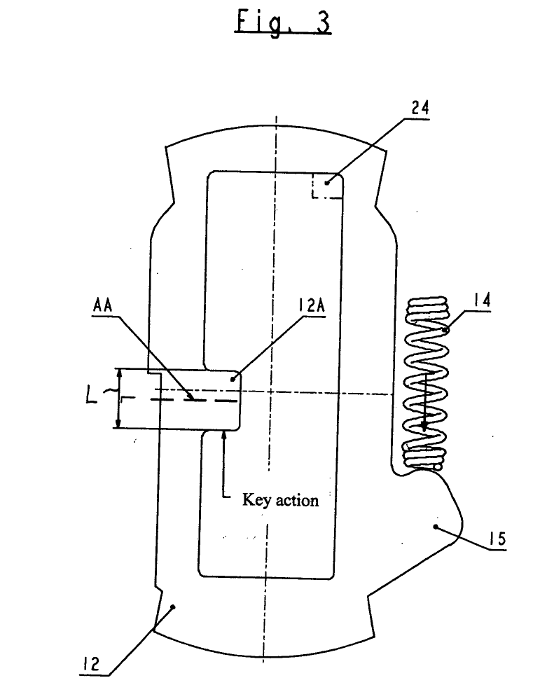

A scaled-up view of a tumbler 12 is shown in FIG. 3. This tumbler 12 presents a finger 15 upon which the end of the spring 14 rests. The tumbler 12 bears a control nib 12A. The width L of the nib may be fixed or variable from one tumbler to the next. The position of the nib along an inner edge of the tumbler 12 is variable from one tumbler to the next. For instance, two adjacent tumblers may have their nibs (in the locking and/or unlocking position) spaced apart from another by a distance (the distance between their respective median axis M) of less than 1 mm, notably less than 0.75 mm, for example 0.6 mm or even less. This possible close position of the nibs of different tumblers thus enables the number of different tumbler types and hence of possible combinations to be multiplied.

To ensure a sufficient number of possible combinations, both the tumblers and their nibs are adapted to cooperate with a channel on a key of variable width, said variable width presenting a minimum width at least equal to the width of the nibs.

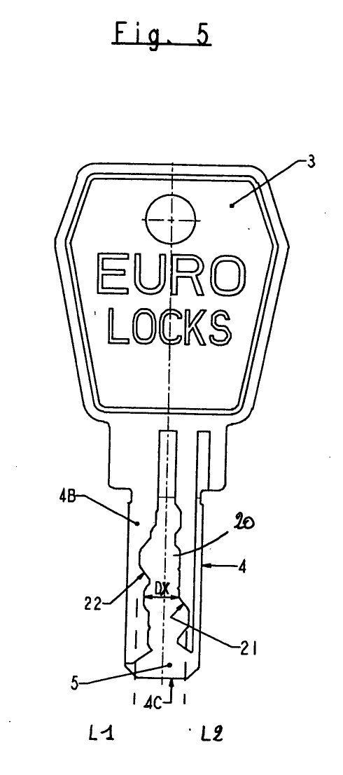

Accordingly, the hollows or peaks of the channel 20 (see FIG. 5) extend in an area defined between two longitudinal lines L1, L2 spaced apart from one another by a distance corresponding to at least the width of the nibs. In order to make the locking device even more difficult to pick, the tumblers and nibs are selected at least from a group of not less than three tumblers featuring a nib of which one longitudinal edge cooperating with an edge of the channel on the key extends between two extreme positions (see FIG. 5).

The end 4C of the key 3 presents a flared channel 20 to facilitate the passage of the tumbler nibs in the channel 20. The same goes for the end 25C of the master key 25.

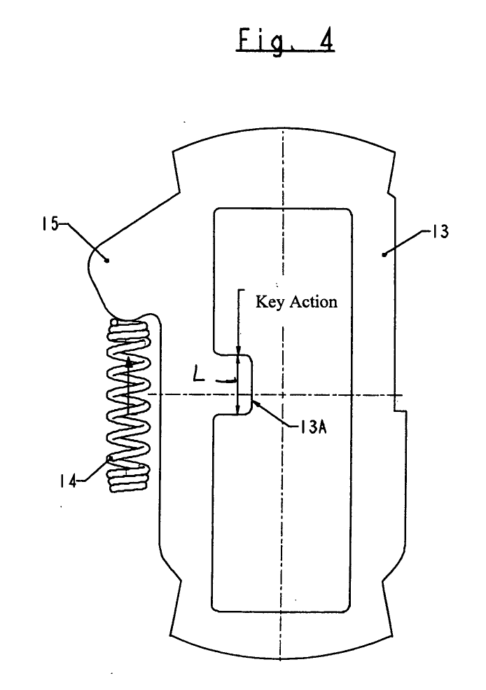

The tumbler seen in FIG. 4 is similar to the one in FIG. 3, except for the fact that the finger 15 is situated on the same side as the control nib 13A.

One useful application for this new rotor and these new keys with their high level of resistance to fraudulent opening is the protection of property such as skis, bicycles, dinghies, accessories, etc. being transported on the roof or tailgate of cars, or in caravans and mobile homes. This therefore also makes it possible to ensure that the object is suitably locked and that articles cannot be used in the event that the rotor is improperly moved, notably opened. There are generally a number of different locking devices in a caravan or on the various accessories transported on the roof of a car. With security and user-friendliness in mind, it is advantageous for all the locking devices of a caravan or accessories on the roof of a car to be fitted with rotors having the same combination, which is the reason for the attraction of removable rotors to be replaced with rotors having the same combination in accordance with this new invention.

Patents EP 0350474, U.S. Pat. No. 4,976,123, EP 0494062, U.S. Pat. No. 5,119,654, the contents of which are incorporated into the present description by reference, show the concept of locking devices with a barrel or rotor that can be removed with the help of a removal key and a two-ended retainer (EP 0350474; U.S. Pat. No. 4,976,123); or alternatively of a two-ended retainer operatively associated with a nib on the rotor (EP 0494062; U.S. Pat. No. 5,119,654). The servant keys for the rotors outlined in these patents are of the conventional type with one or two edges provided with teeth which act on the nibs of the tumblers.

The use of rotors and keys according to this new invention can advantageously increase the ability of the locking devices to withstand being picked, and therefore the security of personal possessions.

It is therefore an object of the present invention to present a new design of rotor and the keys for it, which can easily be inserted and which, moreover, can be removed without the need to dismantle the locking device, and which can advantageously be accommodated in the existing housing of the locking device, in place of the old rotors.

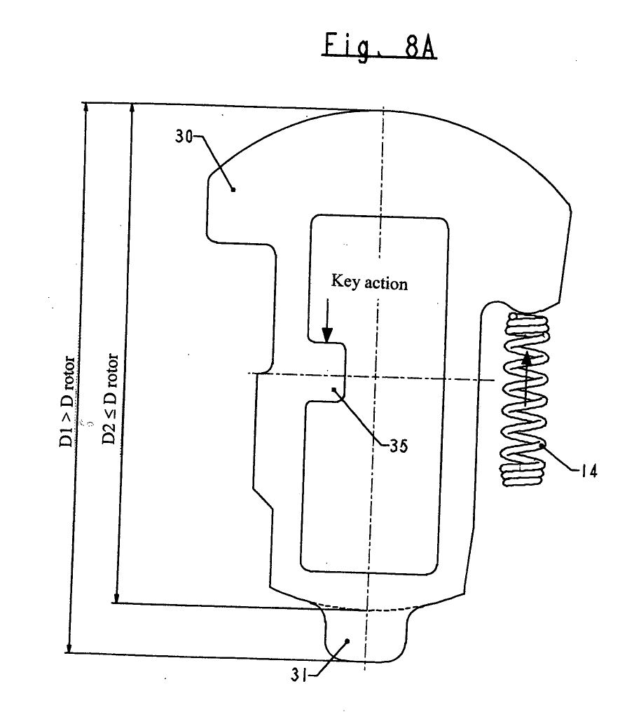

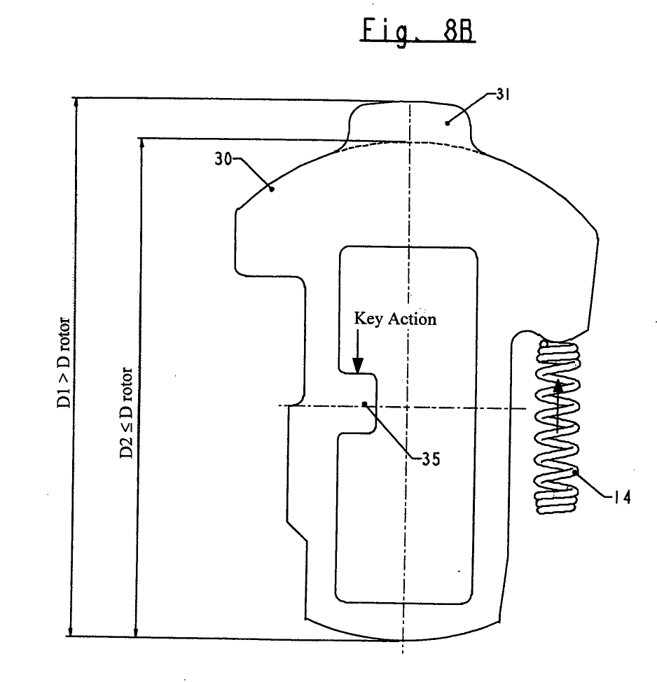

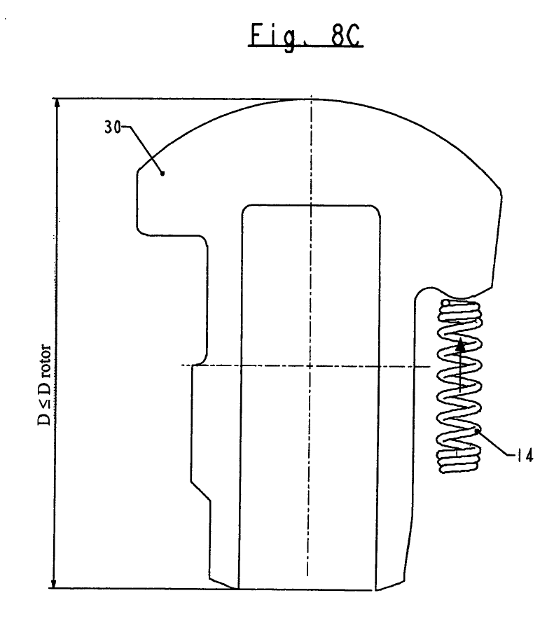

Under such an arrangement, the rotor has tumblers (12, 13) as outlined above, but in addition there is an extra slot for receiving a retainer such as the one shown in FIGS. 7B, 7C for the rotor and in FIGS. 8, 8A, 8B and 8C for the retainer.

Under the action of a spring, the retainer is pushed into an annular slot 32 in the housing 2 in which its broad end is accommodated and the rotor is thus held in the housing. The servant key or master key actuate the tumblers (12, 13), and allow the rotor to rotate; however, these keys do not come into contact with the retainer, which remains accommodated in the annular groove and retains the rotor.

The housing (FIG. 10A) has an annular groove 32 and two opposing longitudinal grooves (42, 43) which allow the tumblers to move under the action of the springs and keys; and advantageously a slope in front of one of the two grooves which facilitates the insertion of the rotor equipped with its retainer into the housing.

Such a rotor equipped with an open retainer (FIG. 8C) will thus be able to be pushed into the housing 2 by presenting the broad end facing the slope, and the broad end of the retainer (FIG. 8C) will then become seated in the annular groove 32 in order to retain the rotor in the housing.

In the application concerning a removable rotor, the retainer inserted into the rotor will for example be of the type illustrated in FIG. 8, and operatively associated with a housing illustrated in FIG. 10B which possesses an annular groove 32 and two longitudinal grooves (42, 43). Only one of these longitudinal grooves opens onto the annular groove 32. At the start thereof the other longitudinal groove features a slope with a width at least equal to the broad end of the retainer seen in FIG. 8; this slope ensures that the rotor can readily be inserted into the housing with or without having introduced the key, and above all without having recourse to the use of a removal key detailed hereinbelow.

In order to maintain the security of a locking device equipped with such a rotor having a double-ended retainer (FIG. 8), the unlocked position of the rotor will be such that the broad end of the retainer will be adjacent to the longitudinal groove that does not open onto the annular groove 32.

In the unlocked position it will therefore be the narrow end of the retainer that will lie opposite to the open longitudinal groove 43 on the annular groove.

The broad end of the retainer is wider than the longitudinal grooves (42, 43) of the housing and the narrow end is narrower than the longitudinal groove 43 which opens onto the annular groove 32 (FIG. 10C).

Some arrangements show one narrow end of the retainer substantially reduced in width (FIG. 8A) and the opening of the longitudinal groove 43 onto the annular groove 32 is then consequently managed without modifying the operating principle outlined in this invention.

The housings may have two, four, six or more longitudinal grooves (42, 43) for movement of the tumblers, but only one (43) must open onto the annular groove 32 in order to ensure that the rotor can be removed only in the unlocked position.

A removal key, which is generally an elongate servant key, is equipped with a channel to enable it to operate the nib of the retainer in a downward direction, resulting in the broad end of the retainer (FIG. 8) disappearing in the rotor and only the narrow end of the retainer getting past the rotor.

In the unlocked mode only, the narrow end of the retainer is then situated opposite the longitudinal groove (43) which is open onto the annular groove 32, and accordingly it is possible to remove the rotor from the housing and introduce another rotor thereinto.

In some applications master keys are not wanted and in order to remove a rotor from its housing whilst ensuring a sufficient level of security it will first be necessary to use the servant key to turn the rotor and thereby unlock the locking device.

Once the servant key has been removed, the removal key is introduced, lowering the retainer, and the rotor is removed from the housing; another rotor can thus be introduced.

For other applications (locker rooms in factories, schools, offices, etc.) it is desirable to have a master key, and hence in addition to the option of removing the rotor in the unlocked position with a simple removal key there is the option of having an elongated master key or “master removal key” to actuate the retainer as explained earlier.

In such a scenario, the insertion of a master removal key makes it possible to unlock all the tumblers (12; 13) and furthermore to lower the retainer. The rotor can therefore be turned from the locked position to the unlocked position in which the narrow end of the retainer (FIG. 8) is then situated opposite the longitudinal groove (43) opening onto the annular groove 32 and the rotor can thus be removed.

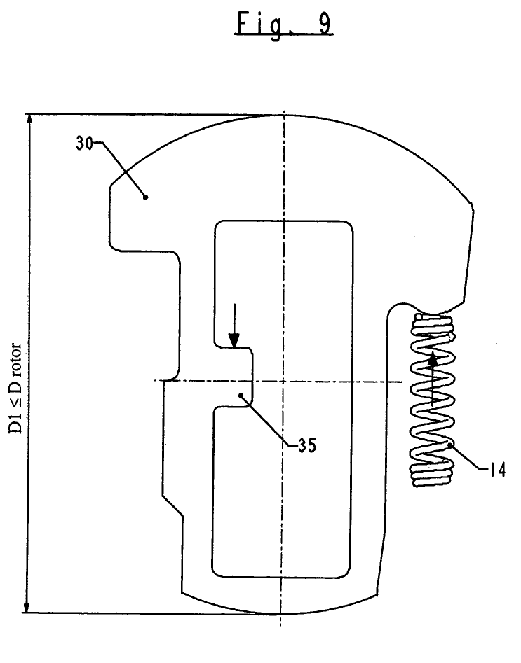

Another form of embodiment of a removable rotor is one in which the two-ended retainer (FIG. 9) has a diameter substantially equal to or slightly less than the diameter of the rotor (D rotor) and there is an extra nib (40) on the rotor, accommodated in the same plane as the retainer and preferably situated in the half of the cylindrical periphery of the rotor lying opposite the broad end of the retainer (FIG. 7C). It is obvious that the extra nib (40) can be in another position, such a position not accomodated in the plane of the retainer and/or in a position forming an angle comprised between 15° and 175°, such as about 90° with respect to the direction of movement of the retainer.

The housing for such a rotor is illustrated in FIG. 10D; it possesses an annular groove 32 in which the broad end of the retainer seen in FIG. 9 will be seated.

There are two longitudinal grooves (42, 43), which are diametrically opposed to receive the displacement of the tumblers (12; 13).

The retainer (FIG. 9) has a broad end whose width is substantially greater than the width of the two longitudinal grooves.

The tumblers (12, 13) move in two longitudinal grooves (42, 43) on the housing which are able to open (partially or fully), or not, onto the annular groove 32.

In addition the housing (FIG. 10D) has another longitudinal groove 34 which receives the nib 40 of the rotor when the latter is inserted into the housing. This longitudinal groove 34 opens onto the annular groove 32.

To facilitate the insertion of such a rotor without having to use a removal key, it is practical to position a slope having a width greater than or equal to the large width of the retainer at the start of the longitudinal groove that faces the broad end of the retainer when the nib 40 is situated opposite its groove 34 in the housing. When the rotor is positioned in the housing, the broad end of the retainer enters the annular groove 32. To remove the rotor it is first necessary to introduce the servant key or the master key (if adapted for this purpose) and turn the rotor as far as the unlocked position in which the nib 40 of the rotor will lie opposite the longitudinal groove 34. The servant key is now removed and the (elongate) removal key, which lowers the retainer or staple (FIG. 9) and allows the rotor to be removed and replaced with a new rotor, is introduced. Here, too, the option exists of using a master removal key which then allows the rotor to be unlocked and removed.

Another form of embodiment of a locking device featuring a retainer-type rotor (FIG. 9) and nib 40 is one that involves a housing whose longitudinal groove 34 is not lying opposite the nib 40 of the rotor when the cylinder is in the unlocked position with the tumblers at rest in the two longitudinal grooves.

In such a case, inserting a straightforward removal key does not make it possible to withdraw the rotor since the nib 40 is not situated opposite the longitudinal groove 34. What is then needed is a master removal key which makes it possible to lower the retainer and rotate the rotor until the nib 40 lies opposite the groove 34, which enables the rotor to be withdrawn and replaced with a new rotor. Some designs for a two-ended closed retainer have the second (narrow) end accommodated above the first (broad) end, as depicted in FIG. 8B.

In this case diameter D2 is essentially equal to, but advantageously less than, the diameter of the rotor (D rotor) and diameter D1 is essentially bigger than the diameter of the rotor (D rotor).

In the unlocked position, inserting the removal key or the master removal key only allows the second (narrow) end 31 of the retainer accommodated above the first (broad) end to remain outside the rotor.

In this case it is the longitudinal groove 42 which must be open onto the annular groove 32, since it is in this position that the rotor is unlocked.

A suitable aperture between the annular groove 32 and the required longitudinal groove (in this case 42) enables the rotor to be withdrawn (FIG. 10D).

Such an embodiment operatively associated with a rotor of this new invention forms an integral part of the present invention.

It will be apparent that rather than using a staple or retainer adapted to be operated with a key, it is possible to use other systems to hold the rotor 1 in the housing. For example, the projection 40 may be adapted to move against a spring and may present a pent face so as to push the projection 40 into the body of the rotor 1 for as long as the projection 40 has not reached the annular groove. When the projection 40 is situated opposite said groove, the spring pushes the latter into the groove. The projection 40 then presents a face forming a limit stop to stand in the way of the rotor's removal.

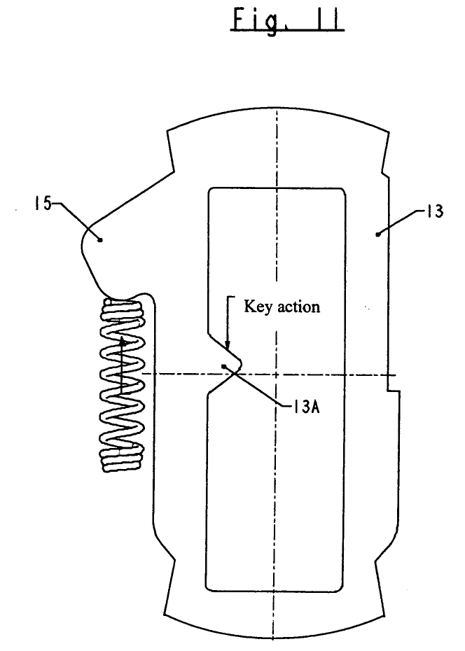

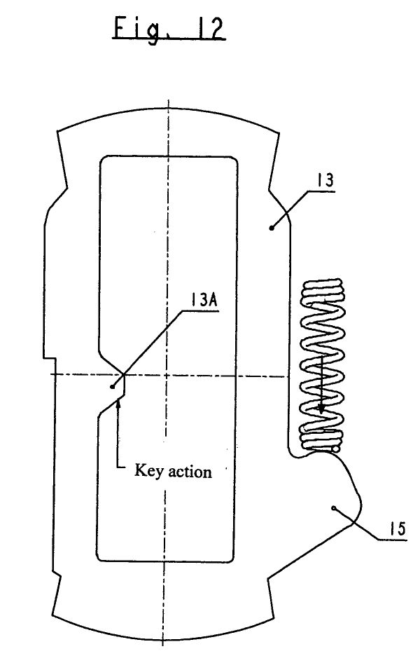

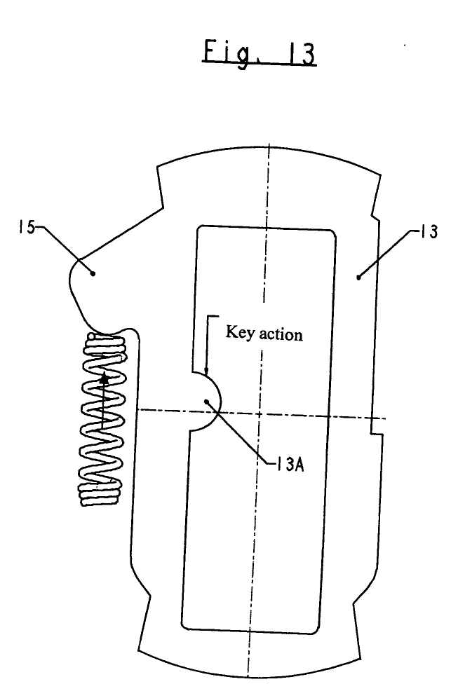

FIGS. 11, 12 and 13 depict specific forms of tumblers 12, 13 in respect of which the nibs 12A, 13A present two sloping edges, for example with an angle α of more than 30° (for instance 45 to 75°) with respect to a plane (P) perpendicular to the direction in which the tumblers (M) move, thereby making any attempt at picking the locking device even more complicated. In FIG. 11 the tumbler nib is triangular, while the nib seen in FIG. 12 is trapezoidal. In FIG. 13 the nib has a rounded shape.

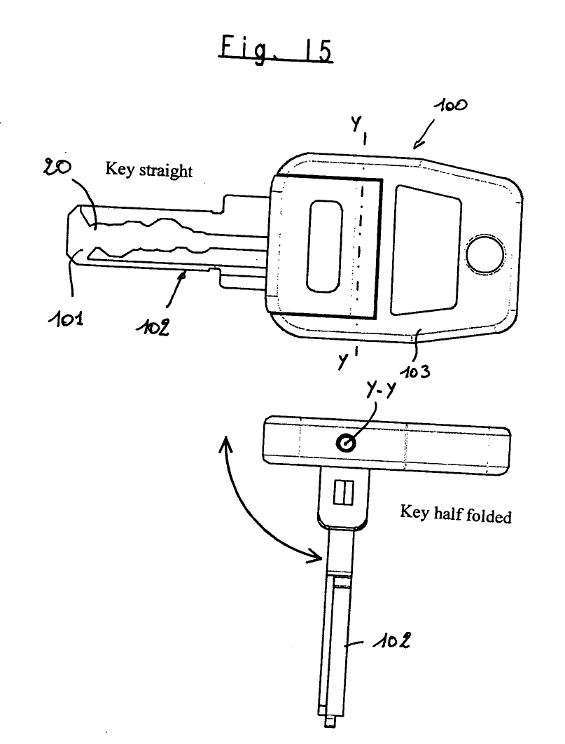

FIG. 15 is a view of a key 100 presenting a tumbler nib control channel 20 on one face 101 of its flat side 102. This key 100 features a support 103 which is pivotally mounted (axis Y-Y) with respect to the flat side 102. FIG. 15 shows the key in the straight and half-folded positions. When the key is fully folded away, the support advantageously provides at least partial protection for the flat side 102.

The key illustrated is a single-entry key.

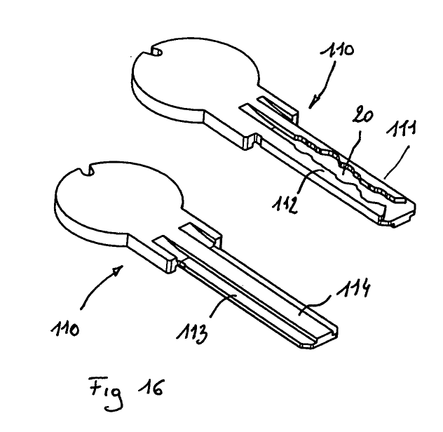

FIG. 16 is a perspective view showing both sides of a single-entry key 110. This key has a flat side 111 whose face 112 presents a tumbler nib control channel 20, while the other face 113 presents a longitudinal projection acting as a strengthening and guiding means for the flat side and as a means for limiting the key's access to rotors having at least one appropriate profile.

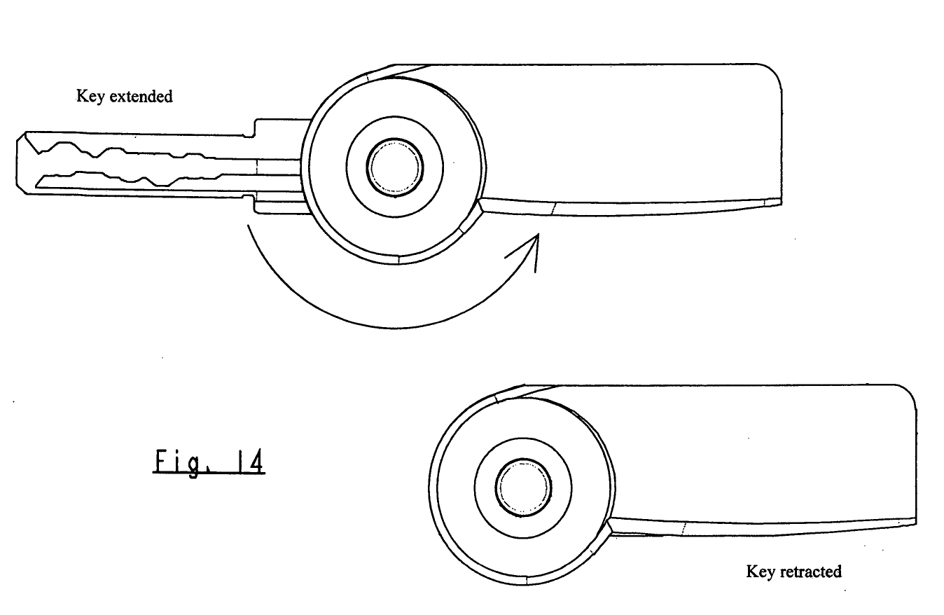

FIG. 14 also depicts a foldaway key that can be fully accommodated in its support when folded away.

What we claim is:

1. A rotor for a rotor-type locking device that is at least opened with a key, said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other.

2. The rotor of claim 1, in which for each tumbler, the return means is a return spring.

3. The rotor of claim 1, in which the chamber is defined at least between two inner faces at least partially opposed, and in which the nibs of said at least first, second and third tumblers in their locking position extend at least partially into the chamber along one of said opposed inner faces.

4. The rotor of claim 1, which has at least four locking tumblers at least two first tumblers is brought into the unlocking position by a displacement in a first direction while at least two other tumblers are brought into the unlocking position by a displacement in a second direction different from the first direction.

5. The rotor of claim 1, which has at least four locking tumblers at least two first tumblers is brought into the unlocking position by a displacement in a first direction, while at least two other tumblers are brought into the unlocking position by a displacement in a second direction opposed from the first direction.

6. The rotor of claim 1, which has at least five locking tumblers.

7. The rotor of claim 1, which has at least seven locking tumblers.

8. The rotor of claim 1, wherein the chamber presents a first and a second internal face situated opposite one another, with at least three tumblers having their controlling nib turned towards the first internal face, while at least another tumbler has its controlling nib turned towards the second internal face.

9. The rotor of claim 1, in which at least one tumbler presents at least one spigot (24) adapted to allow said tumbler to be brought from its locked position into the unlocked position by means of a master key.

10. The rotor of claim 1, in which several tumblers present each at least one spigot (24) adapted to allow each tumbler to be brought from its locked position into the unlocked position by means of a master key.

11. The rotor of claim 1, in which the chamber has a longitudinal axis corresponding to the key insertion axis and a substantially rectangular cross-section, whereby the nibs of the tumblers are adapted to cooperate with a key presenting on at least one of its faces a channel defined between a first longitudinal edge and a second longitudinal edge the first edge being adapted to displace at least one nib of at least a first tumbler in a first direction while the second edge is adapted to displace at least one nib of a second and third tumblers in a direction opposite to the first direction.

12. The rotor of claim 1, in which the chamber has a longitudinal axis corresponding to the key insertion axis and a substantially rectangular cross-section, whereby the nibs of the tumblers are adapted to cooperate with a key presenting on at least one of its faces a channel defined between a first longitudinal edge and a second longitudinal edge the first edge being adapted to displace at least one nib of at least a first group of tumbler in a first direction while the second edge is adapted to displace at least one nib of a second group of tumblers in a direction opposite to the first direction.

13. The rotor of claim 1, in which all the tumbler control nibs are situated along only one inner face of the central chamber, with the result that it is adapted to cooperate with a key featuring on only one face a channel for controlling the tumbler nibs.

14. The rotor of claim 1, in which at least one tumbler has a spigot adapted to allow said tumbler to be brought from its locked position into the unlocked position by means of a master key, and in which all the tumbler control nibs are situated along only one inner face of the central chamber, with the result that it is adapted to cooperate with a master key featuring on only one face a channel for controlling tumbler nibs, and on an edge of said master key, at least one tooth, with said tooth being adapted to act upon one tumbler spigot.

15. The rotor of claim 1, in which several tumblers have each a spigot adapted to allow said tumblers to be brought from its locked position into the unlocked position by means of a master key, and in which all the tumbler control nibs are situated along only one inner face of the central chamber, with the result that it is adapted to cooperate with a master key featuring on only one face a channel for controlling tumbler nibs, and on at least one edge of said master key, teeth being adapted to act upon the tumbler spigots.

16. The rotor of claim 14, in which the chamber features a central chamber defined between at least a first face and a second face which are situated opposite one another, in which the tumbler control nibs are situated only along one of said opposite first and second faces of the central chamber, with the result that the latter is adapted to cooperate with a key with two opposite faces, whereby one of said opposite face presents a tumbler nib control channel.

17. The rotor of claim 14, in which the chamber features a central chamber defined between at least a first face and a second face which are situated opposite one another, in which the tumbler control nibs are situated only along one of said opposite first and second faces of the central chamber, with the result that the latter is adapted to cooperate with a key with two opposite faces, whereby one of said opposite face presents a tumbler nib control channel.

18. The rotor of claim 15, in which the chamber features a central chamber defined between at least a first face and a second face which are situated opposite one another, in which the tumbler control nibs are situated only along one of said opposite first and second faces of the central chamber, with the result that the latter is adapted to cooperate with a master key with two opposite faces, whereby one of said opposite face presents a tumbler nib control channel, whereby said master key has at least one bitting provided with at least one tooth adapted to act on at least one tumbler spigot.

19. The rotor of claim 15, in which the chamber features a central chamber defined between at least a first face and a second face which are situated opposite one another, in which the tumbler control nibs are situated only along one of said opposite first and second faces of the central chamber, with the result that the latter is adapted to cooperate with a master key with two opposite faces, whereby one of said opposite face presents a tumbler nib control channel, whereby said master key has at least two bittings provided each with at least one tooth adapted to act on at least one tumbler spigot.

20. The rotor of claim 1, in which the nibs of the tumblers are of substantially the same width whereby said nibs are adapted to cooperate with a key presenting on at least one of its faces a channel defined between a first longitudinal edge and a second longitudinal edge the first edge being adapted to displace at least one nib of at least a first tumbler in a first direction while the second edge is adapted to displace at least one nib of a second and third tumblers in a direction opposite to the first direction the longitudinal edges of the channel being spaced apart from one another by a minimum distance corresponding to at least the maximum width of the tumbler nib.

21. The rotor of claim 1, in which the tumblers are seated in slots spaced equidistantly apart.

22. The rotor of claim 1, in which the tumblers are seated in slots spaced apart, whereby two adjacent slots are distant from each other by a first distance, while two other adjacent slots are distant from each other by a second distance different from the first distance.

23. The rotor of claim 1, in which the tumblers are seated in slots spaced apart, said slots forming at least two groups of separate slots, whereby two adjacent slots of the first group are distant from each other by a first distance, while two adjacent slots of the second group are distant from each other by a second distance different from the first distance.

24. The rotor of claim 1, in which both tumblers and the nibs thereof are adapted to cooperate with a key presenting a channel with a variable width said channel extending in an area defined between two longitudinal lines spaced apart from one another by a distance corresponding to at least the width of the nibs.

25. The rotor of claim 24, in which the nib of each tumbler is placed in a slot so as to be able to move between two extreme positions, and in which the maximum width separating the two longitudinal lines is a function of the distance between the extreme positions of the nibs in the various tumblers.

26. The rotor of claim 25, which is adapted to cooperate with a key presenting a face with a channel, whereby the tumblers are selected at least from a group of not less than three tumblers presenting a nib of which one longitudinal edge cooperating with an edge of the key channel extends between two extreme positions.

27. The rotor of claim 1, in which the nib of at least one tumbler has a variable width.

28. The rotor of claim 1, in which the nib of at least one tumbler has a variable shape.

29. The rotor of claim 1, in which each tumbler moves in its slot according to a direction by the action of a key presenting a channel with at least one sloping, whereby the nib of at least one tumbler presents a sloping with respect to the plane perpendicular to the direction in which the tumbler moves by the action of the key, said face being adapted to cooperate with a sloping of the channel of the key.

30. The rotor of claim 1, in which each tumbler moves in its slot according to a direction by the action of a key presenting a channel with at least one rounded edge, whereby the nib of at least one tumbler presents a rounded face with respect to the plane perpendicular to the direction in which the tumbler moves by the action of the key, said face being adapted to cooperate with a rounded edge of the channel of the key.

31. The rotor of claim 1, in which the nib of the tumbler has a shape selected among the group consisting of substantially triangular shape, rectangular shapes, square shape, rounded shape, trapezoidal shape and combination thereof.

32. The rotor of claim 31, which is adapted to cooperate with a key presenting a face with a channel, whereby the shape of the channel of the key is adapted to the shape of the nib.

33. The rotor of claim 1, in which for several tumblers, the return means is a spring, whereby the springs acting on tumblers against a movement in a first direction are all situated on a first inner face of the chamber, while the springs acting on tumblers against a movement in an opposite direction to said first direction are situated on a second face opposite to the first side of the chamber.

34. The rotor of claim 33, in which the springs acting on the tumblers are alternately spaced springs, according to a spacing selected among the group consisting of individually spacing, unitarily spacing, groupwise spacing and combinations thereof.

35. The rotor of claim 1, in which for several tumblers, the return means is a spring, the springs of the tumblers are positioned in seats selected from the group consisting of separate seats, diametrically opposed seats, seats located so as to mirror one another, and combinations thereof.

36. The rotor of claim 1, in which for several tumblers, the return means is a spring, in which tumblers are placed in groups of tumblers, whereby the springs of the groups of tumblers are positioned in seats selected from the group consisting of separate seats, diametrically opposed seats, seats located so as to mirror one another, and combinations thereof.

37. The rotor of claim 1, in which at least one slot receives at least two tumblers selected among the group consisting of tumblers sliding in the same direction against the action of at least one return means and tumblers sliding in opposite direction against the action of at least one return means.

38. The rotor of claim 2, in which at least one slot receives at least two tumblers selected among the group consisting of tumblers sliding in the same direction against the action of at least one return spring and tumblers sliding in opposite direction against the action of at least one return spring.

39. The rotor of claim 1, which features at least one means for retaining the rotor in a housing of a locking device.

40. The rotor of claim 39, in which the means for retaining the rotor in a housing of a locking device is selected among the group consisting of open retainer, closed retainer, open staple, closed staple and combinations thereof.

41. The rotor of claim 1, which features at least one means for retaining the rotor in a housing of a locking device, whereby the means for retaining the rotor in a housing of a locking device is selected among the group consisting of open retainer, closed retainer, open staple, closed staple and combinations thereof and whereby the means for retaining the rotor is mounted so as to slide in a slot in the rotor.

42. The rotor of claim 1, which features at least one means for retaining the rotor in a housing of a locking device, whereby the means for retaining the rotor in a housing of a locking device is selected among the group consisting of open retainer, closed retainer, open staple, closed staple and combinations thereof and whereby the means for retaining the rotor is mounted so as to slide in a slot in the rotor against the action of a return means.

43. The rotor of claim 1, which features at least one means for retaining the rotor in a housing of a locking device, whereby the means for retaining the rotor in a housing of a locking device is selected among the group consisting of open retainer, closed retainer, open staple, closed staple and combinations thereof and whereby the means for retaining the rotor is mounted so as to slide in a slot in the rotor against the action of at least one spring.

44. The rotor of claim 41, in which the means for retaining the rotor in the housing is a nib borne on the rotor, said nib being selected among the group consisting of nib adapted to slide, deformable nib and combination thereof.

45. A rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said rotor is adapted to be placed in a housing of a locking device, whereby the rotor features at least one means designed to cooperate with at least one tool for removing the rotor from its housing without damaging the rotor and its housing and/or without even partially dismantling the locking device.

46. A rotor for a rotor-type locking device that is at least opened with a key, said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby the rotor is adapted to be placed in a housing of a locking device, whereby the rotor features at least one means designed to cooperate with at least one tool for removing the rotor from its housing without damaging the rotor and its housing and/or without even partially dismantling the locking device.

47. The rotor of claim 45, in which the means designed to cooperate with at least one tool is selected among the group consisting of a nib, a spigot, and combination thereof.

48. The rotor of claim 45, in which the means designed to cooperate with at least one tool is selected among the group consisting of a nib mounted on at least one leg of an open retainer, a spigot mounted on at least one leg of an open retainer, a nib mounted on a closer retainer, a spigot mounted on a closed retainer, and combinations thereof.

49. The rotor of claim 48, in which the retainer is of the closed type (FIGS. 8, 8A, 8B) with two ends spaced apart from one another by a distance greater than the diameter of the portion of the rotor adjacent to the retainer.

50. The rotor of claim 45, which is adapted to be placed in a housing of a locking device, whereby the rotor features at least one means designed to cooperate with at least one tool for removing the rotor from its housing without damaging the rotor and its housing and/or without even partially dismantling the locking device, whereby the rotor is adapted to cooperate with a housing presenting an annular groove designed to receive at least a portion of the retainer for retaining the rotor in the housing, and at least one groove at least partially open onto the annular groove.

51. The rotor of claim 45, which is adapted to be placed in a housing of a locking device, whereby the rotor features at least one means designed to cooperate with at least one tool for removing the rotor from its housing without damaging the rotor and its housing and/or without even partially dismantling the locking device, whereby the rotor is adapted to cooperate with a housing presenting an annular groove designed to receive at least a portion of the retainer for retaining the rotor in the housing, and at least one groove selected among the group consisting of substantially longitudinal groove and substantially axial groove, which at least partially open onto the annular groove.

52. The rotor of claim 50, in which the groove which at least partially opens onto the annular groove has a cross section, whereby the retainer presents a first end with at least a portion having a width that is broader than the cross section of the groove, and a second end with a width that is narrower than the cross section of the groove which opens at least partially onto the annular groove.

53. The rotor of claim 52, which is adapted to cooperate with a removal key, said key being selected from the group consisting of a key presenting either a channel designed to move a nib of the retainer and hence the retainer itself, and a key presenting an edge with a tooth that presses on a spigot on the retainer in order to move the latter, said key being adapted to ensure a sufficient movement of the retainer for displacing its broad end from the annular groove in the housing and allow the removal of the rotor after the latter has been brought into an unlocked position.

54. The rotor of claim 50, which is adapted to cooperate with a removal key corresponding to a master key having a portion designed to control the removal of the rotor, said master key making it possible to unlock the rotor in order to arrive, after rotation of said rotor, at a position in which the rotor is removed, or designed to allow removal thereof.

55. The rotor of claim 45, in which the rotor has a portion in which the retainer is adapted to be housed, said portion being defined by a diameter, and in which the retainer is of the two-ended closed type and has a cross-sectional form defined in a circle of a diameter selected among the group consisting of a diameter substantially equal to the diameter of said portion of the rotor and a diameter smaller than the diameter of the portion of the rotor.

56. The rotor of claim 55, in which the retainer is placed in a slot in which the retainer is able to slide along a sliding plane, and in which the rotor has a nib substantially situated in the sliding plane of the slot.

57. The rotor of claim 56, in which the retainer presents one broad end, whereby the nib is positioned in an area that is not adjacent to the broad end of the retainer.

58. The rotor of claim 45, in which the rotor has a portion in which the retainer is adapted to be housed, said portion being defined by a diameter, and in which the retainer is of the two-ended closed type and has a cross-sectional form defined in a circle of a diameter selected among the group consisting of a diameter substantially equal to the diameter of said portion of the rotor and a diameter smaller than the diameter of the portion of the rotor, and in which the retainer presents one broad end, whereby the nib is positioned in an area that is not adjacent to the broad end of the retainer and substantially opposite the broad end of the retainer.

59. The rotor of claim 45, in which the rotor is adapted to cooperate with a housing featuring an annular groove designed to receive a portion of the retainer, a longitudinal groove allowing the passage of the nib of the rotor, and at least two longitudinal grooves for tumblers, said two grooves opening onto the annular groove.

60. The rotor of claim 45, in which the means designed to cooperate with at least one tool is a retainer having at least two legs and a small end, whereby the retainer features a control nib along one of its legs, said retainer having its small end open.

61. The rotor of claim 45, in which the means designed to cooperate with at least one tool is a closed retainer having two ends, both of which are of substantially the same width, advantageously smaller than the longitudinal grooves for tumblers, whereby the rotor is adapted to cooperate with a housing presenting at least two longitudinal grooves for tumblers, one of which opens onto the annular groove.

62. The rotor of claim 45, using tumblers with control nibs situated along two internal faces of the chamber of the rotor.

63. The rotor of claim 45, which is adapted to operate with a single-entry key with a channel on each face, said two channels being asymmetrical.

64. The rotor of claim 63, in which the key has at least an end provided with at least one tooth.

65. A rotor-type locking device that is at least opened with a key, said locking device having at least one housing cooperating with at least one rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other.

66. The locking device of claim 65, in which for each tumbler of the rotor, the return means is a return spring.

67. The locking device of claim 65, in which the chamber of the rotor is defined at least between two inner faces at least partially opposed, and in which the nibs of said at least first, second and third tumblers in their locking position extend at least partially into the chamber along one of said opposed inner faces.

68. The locking device of claim 65, in which the rotor has at least four locking tumblers at least two first tumblers are brought into the unlocking position by a displacement in a first direction while at least two other tumblers are brought into the unlocking position by a displacement in a second direction different from the first direction.

69. The locking device of claim 65, in which the rotor has at least four locking tumblers at least two first tumblers are brought into the unlocking position by a displacement in a first direction while at least two other tumblers are brought into the unlocking position by a displacement in a second direction opposed from the first direction.

70. The locking device of claim 65, in which the rotor has at least five locking tumblers.

71. The locking device of claim 65, in which the rotor has at least seven locking tumblers.

72. The locking device of claim 65, wherein the chamber of the rotor presents a first and a second internal face situated opposite one another, with at least three tumblers having their controlling nib turned towards the first internal face, while at least another tumbler has its controlling nib turned towards the second internal face.

73. The locking device of claim 65, in which at least one tumbler of the rotor presents at least one spigot adapted to allow said tumbler to be brought from its locked position into the unlocked position by means of a master key.

74. The locking device of claim 65, in which several tumblers of the rotor present each at least one spigot adapted to allow each tumbler to be brought from its locked position into the unlocked position by means of a master key.

75. The locking device of claim 65, in which the chamber of the rotor has a longitudinal axis corresponding to the key insertion axis and a substantially rectangular cross-section, whereby the nibs of the tumblers are adapted to cooperate with a key presenting on at least one of its faces a channel defined between a first longitudinal edge and a second longitudinal edge the first edge being adapted to displace at least one nib of at least a first tumbler in a first direction while the second edge is adapted to displace at least one nib of a second and third tumblers in a direction opposite to the first direction.

76. The locking device of claim 65, in which the chamber of the rotor has a longitudinal axis corresponding to the key insertion axis and a substantially rectangular cross-section, whereby the nibs of the tumblers are adapted to cooperate with a key presenting on at least one of its faces a channel defined between a first longitudinal edge and a second longitudinal edge the first edge being adapted to displace at least one nib of at least a first group of tumbler in a first direction while the second edge is adapted to displace at least one nib of a second group of tumblers in a direction opposite to the first direction.

77. The locking device of claim 65, in which all the tumblers of the rotor control nibs are situated along only one inner face of the central chamber, with the result that it is adapted to cooperate with a key featuring on only one face a channel for controlling the tumbler nibs.

78. The locking device of claim 65, in which at least one tumbler of the rotor has a spigot adapted to allow said tumbler to be brought from its locked position into the unlocked position by means of a master key, and in which all the tumbler control nibs are situated along only one inner face of the central chamber, with the result that it is adapted to cooperate with a master key featuring on only one face a channel for controlling tumbler nibs, and on an edge of said master key, at least one tooth, with said tooth being adapted to act upon one tumbler spigot.

79. The locking device of claim 65, in which several tumblers of the rotor have each a spigot adapted to allow said tumblers to be brought from its locked position into the unlocked position by means of a master key, and in which all the tumbler control nibs are situated along only one inner face of the central chamber, with the result that it is adapted to cooperate with a master key featuring on only one face a channel for controlling tumbler nibs, and on at least one edge of said master key, teeth being adapted to act upon the tumbler spigots.

80. The locking device of claim 78, in which the chamber of the rotor features a central chamber defined between at least a first face and a second face which are situated opposite one another, in which the tumbler control nibs are situated only along one of said opposite first and second faces of the central chamber, with the result that the latter is adapted to cooperate with a key with two opposite faces, whereby one of said opposite face presents a tumbler nib control channel.

81. The locking device of claim 78, in which the chamber of the rotor features a central chamber defined between at least a first face and a second face which are situated opposite one another, in which the tumbler control nibs are situated only along one of said opposite first and second faces of the central chamber, with the result that the latter is adapted to cooperate with a key with two opposite faces, whereby one of said opposite face presents a tumbler nib control channel.

82. The locking device of claim 79, in which the rotor features a central chamber defined between at least a first face and a second face which are situated opposite one another, in which the tumbler control nibs are situated only along one of said opposite first and second faces of the central chamber, with the result that the latter is adapted to cooperate with a master key with two opposite faces, whereby one of said opposite face presents a tumbler nib control channel, whereby said master key has at least one bitting provided with at least one tooth adapted to act on at least one tumbler spigot.

83. The locking device of claim 65, in which the rotor features a central chamber defined between at least a first face and a second face which are situated opposite one another, in which the tumbler control nibs are situated only along one of said opposite first and second faces of the central chamber, with the result that the latter is adapted to cooperate with a master key with two opposite faces, whereby one of said opposite face presents a tumbler nib control channel, whereby said master key has at least two bittings provided each with at least one tooth adapted to act on at least one tumbler spigot.

84. The locking device of claim 65, in which the nibs of the tumblers are of substantially the same width whereby said nibs are adapted to cooperate with a key presenting on at least one of its faces a channel defined between a first longitudinal edge and a second longitudinal edge the first edge being adapted to displace at least one nib of at least a first tumbler in a first direction while the second edge is adapted to displace at least one nib of a second and third tumblers in a direction opposite to the first direction the longitudinal edges of the channel being spaced apart from one another by a minimum distance corresponding to at least the maximum width of the tumbler nib.

85. The locking device of claim 65, in which the tumblers are seated in slots spaced equidistantly apart.

86. The locking device of claim 65, in which the tumblers are seated in slots spaced apart, whereby two adjacent slots are distant from each other by a first distance, while two other adjacent slots are distant from each other by a second distance different from the first distance.

87. The locking device of claim 65, in which the tumblers of the rotor are seated in slots spaced apart, said slots forming at least two groups of separate slots, whereby two adjacent slots of the first group are distant from each other by a first distance, while two adjacent slots of the second group are distant from each other by a second distance different from the first distance.

88. The locking device of claim 65, in which both tumblers and the nibs thereof are adapted to cooperate with a key presenting a channel with a variable width said channel extending in an area defined between two longitudinal lines spaced apart from one another by a distance corresponding to at least the width of the nibs.

89. The locking device of claim 65, in which the nib of each tumbler is placed in a slot so as to be able to move between two extreme positions, and in which the maximum width separating the two longitudinal lines is a function of the distance between the extreme positions of the nibs in the various tumblers.

90. The locking device of claim 89, in which the rotor is adapted to cooperate with a key presenting a face with a channel, whereby the tumblers are selected at least from a group of not less than three tumblers presenting a nib of which one longitudinal edge cooperating with an edge of the key channel extends between two extreme positions.

91. The locking device of claim 65, in which the nib of at least one tumbler has a variable width.

92. The locking device of claim 65, in which the nib of at least one tumbler has a variable shape.

93. The locking device of claim 65, in which each tumbler moves in its slot according to a direction by the action of a key presenting a channel with at least one sloping, whereby the nib of at least one tumbler presents a sloping with respect to the plane perpendicular to the direction in which the tumbler moves by the action of the key, said face being adapted to cooperate with a sloping of the channel of the key.

94. The locking device of claim 65, in which each tumbler moves in its slot according to a direction by the action of a key presenting a channel with at least one rounded edge, whereby the nib of at least one tumbler presents a rounded face with respect to the plane perpendicular to the direction in which the tumbler moves by the action of the key, said face being adapted to cooperate with a rounded edge of the channel of the key.

95. The locking device of claim 65, in which the nib of the tumbler has a shape selected among the group consisting of substantially triangular shape, rectangular shapes, square shape, rounded shape, trapezoidal shape and combination thereof.

96. The locking device of claim 95, which is adapted to cooperate with a key presenting a face with a channel, whereby the shape of the channel of the key is adapted to the shape of the nib.

97. The locking device of claim 65, in which for several tumblers, the return means is a spring, whereby the springs acting on tumblers against a movement in a first direction are all situated on a first inner face of the chamber, while the springs acting on tumblers against a movement in an opposite direction to said first direction are situated on a second face opposite to the first side of the chamber.

98. The locking device of claim 97, in which the springs acting on the tumblers are alternately spaced springs, according to a spacing selected among the group consisting of individually spacing, unitarily spacing, groupwise spacing and combinations thereof.

99. The locking device of claim 65, in which for several tumblers, the return means is a spring, the springs of the tumblers are positioned in seats selected from the group consisting of separate seats, diametrically opposed seats, seats located so as to mirror one another, and combinations thereof.

100. The locking device of claim 65, in which for several tumblers, the return means is a spring, in which tumblers are placed in groups of tumblers, whereby the springs of the groups of tumblers are positioned in seats selected from the group consisting of separate seats, diametrically opposed seats, seats located so as to mirror one another, and combinations thereof.

101. The locking device of claim 65, in which at least one slot of the rotor receives at least two tumblers selected among the group consisting of tumblers sliding in the same direction against the action of at least one return means and tumblers sliding in opposite direction against the action of at least one return means.

102. The locking device of claim 66, in which at least one slot of the rotor receives at least two tumblers selected among the group consisting of tumblers sliding in the same direction against the action of at least one return spring and tumblers sliding in opposite direction against the action of at least one return spring.

103. The locking device of claim 65, which features at least one means for retaining the rotor in the housing of the locking device.

104. The locking device of claim 65, in which the means for retaining the rotor in the housing of the locking device is selected among the group consisting of open retainer, closed retainer, open staple, closed staple and combinations thereof.

105. The locking device of claim 65, in which the rotor features at least one means for retaining the rotor in the housing of the locking device, whereby the means for retaining the rotor in the housing of the locking device is selected among the group consisting of open retainer, closed retainer, open staple, closed staple and combinations thereof and whereby the means for retaining the rotor is mounted so as to slide in a slot in the rotor.

106. The locking device of claim 65, in which the rotor features at least one means for retaining the rotor in the housing of the locking device, whereby the means for retaining the rotor in the housing of the locking device is selected among the group consisting of open retainer, closed retainer, open staple, closed staple and combinations thereof and whereby the means for retaining the rotor is mounted so as to slide in a slot in the rotor against the action of a return means.

107. The locking device of claim 65, in which the rotor features at least one means for retaining the rotor in a housing of a locking device, whereby the means for retaining the rotor in a housing of a locking device is selected among the group consisting of open retainer, closed retainer, open staple, closed staple and combinations thereof and whereby the means for retaining the rotor is mounted so as to slide in a slot in the rotor against the action of at least one spring.

108. The locking device of claim 103, in which the means for retaining the rotor in the housing is a nib borne on the rotor, said nib being selected among the group consisting of nib adapted to slide, deformable nib and combination thereof.

109. A rotor-type locking device that is at least opened with a key, said locking device having at least one housing cooperating with at least one rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said rotor is adapted to be placed in a housing of a locking device, whereby the rotor features at least one means designed to cooperate with at least one tool for removing the rotor from its housing without damaging the rotor and its housing.

110. A rotor-type locking device that is at least opened with a key, said locking device having at least one housing cooperating with at least one rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby the rotor is adapted to be placed in a housing of a locking device, whereby the rotor features at least one means designed to cooperate with at least one tool for removing the rotor from its housing without damaging the rotor and its housing and without even partially dismantling the locking device.

111. The locking device of claim 109, in which the means designed to cooperate with at least one tool is selected among the group consisting of a nib, a spigot, and combination thereof.

112. The locking device of claim 109, in which the means designed to cooperate with at least one tool is selected among the group consisting of a nib mounted on at least one leg of an open retainer, a spigot mounted on at least one leg of an open retainer, a nib mounted on a closer retainer, a spigot mounted on a closed retainer, and combinations thereof.

113. The locking device of claim 109, in which the retainer is of the closed type with two ends spaced apart from one another by a distance greater than the diameter of the portion of the rotor adjacent to the retainer.

114. The locking device of claim 109, in which the rotor is adapted to be placed in a housing of a locking device, whereby the rotor features at least one means designed to cooperate with at least one tool for removing the rotor from its housing without damaging the rotor and its housing and/or without even partially dismantling the locking device, whereby the rotor is adapted to cooperate with a housing presenting an annular groove designed to receive at least a portion of the retainer for retaining the rotor in the housing, and at least one groove at least partially open onto the annular groove.

115. The locking device of claim 109, in which the rotor is adapted to be placed in a housing of a locking device, whereby the rotor features at least one means designed to cooperate with at least one tool for removing the rotor from its housing without damaging the rotor and its housing and/or without even partially dismantling the locking device, whereby the rotor is adapted to cooperate with a housing presenting an annular groove designed to receive at least a portion of the retainer for retaining the rotor in the housing, and at least one groove selected among the group consisting of substantially longitudinal groove and substantially axial groove, which at least partially open onto the annular groove.

116. The locking device of claim 114, in which the groove which at least partially opens onto the annular groove has a cross section, whereby the retainer presents a first end with at least a portion having a width that is broader than the cross section of the groove, and a second end with a width that is narrower than the cross section of the groove which opens at least partially onto the annular groove.

117. The locking device of claim 116, in which the rotor is adapted to cooperate with a removal key, said key being selected from the group consisting of a key presenting either a channel designed to move a nib of the retainer and hence the retainer itself, and a key presenting an edge with a tooth that presses on a spigot on the retainer in order to move the latter, said key being adapted to ensure a sufficient movement of the retainer for displacing its broad end from the annular groove in the housing and allow the removal of the rotor after the latter has been brought into an unlocked position.

118. The locking device of claim 114, in which the rotor is adapted to cooperate with a removal key corresponding to a master key having a portion designed to control the removal of the rotor, said master key making it possible to unlock the rotor in order to arrive, after rotation of said rotor, at a position in which the rotor is removed, or designed to allow removal thereof.

119. The locking device of claim 109, in which the rotor has a portion in which the retainer is adapted to be housed, said portion being defined by a diameter, and in which the retainer is of the two-ended closed type and has a cross-sectional form defined in a circle of a diameter selected among the group consisting of a diameter substantially equal to the diameter of said portion of the rotor and a diameter smaller than the diameter of the portion of the rotor.

120. The locking device of claim 119, in which the retainer is placed in a slot in which the retainer is able to slide along a sliding plane, and in which the rotor has a nib substantially situated in the sliding plane of the slot.

121. The locking device of claim 120, in which the retainer presents one broad end, whereby the nib is positioned in an area that is not adjacent to the broad end of the retainer.

122. The locking device of claim 109, in which the rotor has a portion in which the retainer is adapted to be housed, said portion being defined by a diameter, and in which the retainer is of the two-ended closed type and has a cross-sectional form defined in a circle of a diameter selected among the group consisting of a diameter substantially equal to the diameter of said portion of the rotor and a diameter smaller than the diameter of the portion of the rotor, and in which the retainer presents one broad end, whereby the nib is positioned in an area that is not adjacent to the broad end of the retainer and substantially opposite the broad end of the retainer.

123. The locking device of claim 111, in which the rotor is adapted to cooperate with a housing featuring an annular groove designed to receive a portion of the retainer, a longitudinal groove (34) allowing the passage of the nib of the rotor, and at least two longitudinal grooves for tumblers, said two grooves opening onto the annular groove.

124. The locking device of claim 109, in which the means designed to cooperate with at least one tool is a retainer having at least two legs and a small end, whereby the retainer features a control nib along one of its legs, said retainer having its small end open.

125. The locking device of claim 109, in which the means designed to cooperate with at least one tool is a closed retainer having two ends, both of which are of substantially the same width, advantageously smaller than the longitudinal grooves for tumblers, whereby the rotor is adapted to cooperate with a housing presenting at least two longitudinal grooves for tumblers, one of which opens onto the annular groove.

126. The locking device of claim 109, using tumblers with control nibs situated along two internal faces of the chamber of the rotor.

127. The locking device of claim 109, in which the rotor is adapted to operate with a single-entry key with a channel on each face, said two channels being asymmetrical.

128. The locking device of claim 109, in which the key has at least an end provided with at least one tooth.

129. The locking device of claim 109, in which the retainer presents a broad end and an element designed to fit in an annular groove on the housing, characterised in that the housing presents a slope of a width substantially the same as or greater than the broad end of the retainer and advantageously situated at the beginning of a longitudinal groove for tumblers which does not open out into the annular groove on the housing, said slope facing the broad end of the retainer in a suitable position for inserting the rotor into the housing with or without the key introduced into the rotor, and advantageously without having recourse to a removal key.

130. The locking device of claim 129, in which the retainer comprises a closed retainer having two ends, both of which are of a width substantially equal to or smaller than the longitudinal grooves for tumblers, the housing furthermore presenting at least two longitudinal grooves for tumblers, one of which opens onto the annular groove.

131. The locking device of claim 130, in which the housing presents a slope, said slope being situated at the end of at least one of the longitudinal grooves that do not open onto the annular groove.

132. A key for a rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said key has two opposite faces extending between two edges, said key presenting a tumbler nib control groove on only one of its opposite faces.

133. A key for a rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said key has two opposite faces extending between two edges, said key presenting control channels on two opposing faces.

134. The key of claim 132, in which said channels are symmetrical on both said faces, whereby enabling a double-entry in the rotor.

135. A key for a rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said key has two opposite faces extending between two edges, said key presenting a channel on each opposite face, said two channels being asymmetrical.

136. The key of claim 134, which has at least one tooth on at least one edge of the key.

137. A key for a rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby at least some tumblers are provided each with at least one spigot adapted for cooperating with the key for bringing said tumblers into the unlocking position,
whereby said key has two opposite faces extending between two edges, and whereby the key presents at least one face with a channel designed to act on tumbler nibs and at least one with teeth designed to act on tumbler spigots.

138. The key of claim 137, which presents two opposing faces, each with a channel designed to act on tumbler nibs and two opposing edges with teeth designed to act on tumbler spigots.

139. Removal key for a rotor so as to remove said rotor from a housing of a locking device, whereby said rotor is maintained in said housing by at least a retainer selected among the group consisting of retainer with a nib, a retainer with a spigot and combinations thereof, whereby the key has two opposite faces extending between two edges, whereby the key has at least one characteristic selected from the group consisting of a channel on at least one of its faces in order to operate the nib of the retainer, at least one tooth on at least one of its edges in order to operate the spigot on the retainer, and combinations thereof.

140. The removal key of claim 139, in which the retainer is selected from the group consisting of open retainers and closed retainers.

141. Master removal key for a rotor so as to unlock and remove said rotor from a housing of a locking device, whereby said rotor for a rotor-type locking device that is at least opened with a key said rotor featuring:
a central chamber with at least one aperture adapted for the introduction of at least one portion of the key into the chamber, said chamber being defined at least between two inner faces located at least partly the one in front of the other;
a series of slots which communicate with the central chamber;
locking tumblers which respectively slide in a slot under the action of a return means each tumbler presenting a control nib designed to cooperate with the key introduced into the chamber, so as to bring each tumbler from a locking position into an unlocking position against the action of the return means,
whereby at least a first tumbler is brought into the unlocking position by a displacement in a first direction while at least a second and a third tumblers are brought into the unlocking position by a displacement in a second direction different from the first direction, and
whereby the nibs of said at least first, second and third tumblers in their locking position extend at least partially into the chamber along one of said inner faces located the one in front of the other,
whereby said rotor is maintained in said housing by at least a retainer selected among the group consisting of retainer with a nib, a retainer with a spigot and combinations thereof, whereby the key has two opposite faces extending between two edges, whereby the key has at least a first characteristic selected from the group consisting of a channel on one of its faces for unlocking at least one tumbler, at least one tooth on at least one edge for unlocking at least one tumbler, and combinations thereof, and a second characteristic selected from the group consisting of a channel on at least one of its faces in order to operate the nib of the retainer, at least one tooth on at least one of its edges in order to operate the spigot on the retainer, and combinations thereof. characterised by a channel on at least one of its faces and teeth on at least one of its edges in order to unlocking device the tumblers and lower the retainer via the channel or the teeth on the edge.

142. The removal key of claim 139, in which the retainer is selected from the group consisting of open retainers and closed retainers.

143. The key of claim 135, which is a split key.

144. The key of claim 143, whereby the split key is associated to a protection means in which the key can be at least partially inserted.

145. The use of at least one locking device of claim 65 for limiting the access to at least a portion of an element selected from the group consisting of articles, property, bicycles, caravans, luggage carriers and cabinets.
